(19) United States
(12) Patent Application Publication
(10) Pub. No.: US 2020/0156220 A1
(43) Pub. Date: May 21, 2020

(54) SOCKET

(71) Applicant: Chin-Ying Chou, Taichung City (TW)

(72) Inventor: Chin-Ying Chou, Taichung City (TW)

(21) Appl. No.: 16/197,365

(22) Filed: Nov. 21, 2018

(51) Int. Cl. B25B 13/06; B25B 13/48; B25B 23/00

(52) U.S. Cl. CPC B25B 13/065; B25B 13/46; B25B 23/0071; B25B 13/48

(57) ABSTRACT

A socket includes a connection section and a driving section, and a through hole is defined through the connection section and the driving section. The through hole includes a connection portion, a transition portion and a driving portion. The connection portion is to be connected with a ratchet wrench. The driving portion is to be mounted to a head of a bolt or a nut. A first shoulder is formed between the connection portion and the transition portion, and a second shoulder is formed between the transition portion and the driving portion. When the threaded section is inserted into the socket from the driving portion of the through hole, the first shoulder contacts the distal end of the threaded section of the bolt, and the second shoulder contacts the nut, so that the nut can be rotated.

### BACKGROUND OF THE INVENTION

### 1. Fields of the Invention

The present invention relates to a socket, and more particularly, to a socket with two shoulders formed therein and a shorter axial length.

### 2. Descriptions of Related Art

A conventional socket 40 is disclosed in FIGS. 6 and 7, and the socket 40 is cooperated with a ratchet wrench 30 to rotate a bolt 50 and a nut 60. Generally, the socket has one end connected to the ratchet wrench 30, and the other end of the socket 40 is mounted to the bolt 50 and the nut 60. By repeatedly rotating the ratchet wrench 30, the bolt 50 and the nut 60 are tightened or loosened.

In some cases, as shown in FIG. 7, the head 501 of the bolt 50 is hidden by the board through which the bolt 50 extends. The nut 60 is threadedly connected to the threaded section 502 of the bolt 50. Therefore, the socket 40 is accessed to the bolt 50 from the threaded section 502 of the bolt 50, that is to say, the threaded section 502 of the bolt 50 has to extend through the socket 40 such that the socket 40 is able to mount to the nut 60. It is noted that, as shown in FIG. 6, the socket 60 includes the line L1, the line L2, and the line L3 wherein the distance between the L1 and L2 is larger than the distance between the L1 and L3. When the threaded section 502 is inserted into the socket 40 as shown in FIG. 7, the end of the threaded section 502 is stopped at the shoulder portion in the socket 40, and the socket 40 cannot mount to the nut 60. In this case, the user has to replace another socket to allow the socket to mount to the nut 60. This causes lower efficiency for rotating the nut 60.

The present invention is intended to provide a socket that is designed to eliminate the drawbacks mentioned above.

### SUMMARY OF THE INVENTION

The present invention relates to a socket and comprises a connection section and a driving section, and a through hole is defined through the connection section and the driving section. The through hole includes a connection portion, a transition portion and a driving portion, wherein the connection is to be connected with a ratchet wrench, and the driving portion is to be mounted to a head of a bolt or a nut. The transition portion is located between the connection portion and the driving portion. A first shoulder is formed between the connection portion and the transition portion, and a second shoulder is formed between the transition portion and the driving portion. When the threaded section is inserted into the socket from the driving portion of the through hole, the first shoulder contacts the distal end of the threaded section of the bolt, and the second shoulder contacts the nut.

Preferably, the connection portion of the through hole is a rectangular portion. The transition portion of the through hole is a circular portion. The diameter of the transition portion is smaller or equal to the length of the diagonal of the rectangular portion of the connection portion.

Preferably, the connection portion has at least one notch defined in the inside thereof.

Preferably, the first shoulder is in flush with the lower edge of the at least one notch.

Preferably, a first line X1 is defined to extend from the top surface of the connection section. A second line X2 is defined to pass a middle point of the transition portion and perpendicular to the socket. A third line X3 is defined to pass through the center of the at least one notch and perpendicular to the axis of the socket. A fourth line X4 is defined to extend from the second shoulder. The height of the transition portion is defined as “H”, wherein the “H” is larger than ⅘ of the distance between the third line X3 and fourth line X4. The height of the driving portion 133 is defined as “h”, wherein the “H” is larger than ¼ of the “h”.

Preferably, the diameter of the transition portion is defined as D, and the length of the diagonal of the connection portion 131 is defined as d, wherein D>d.

Preferably, the width of the first shoulder is defined as “a”, the width of the second shoulder is defined as “A”, wherein A>a, and H>A+a.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the socket of the present invention;

FIG. 2 shows a ratchet wrench is to be connected with the socket of the present invention;

FIG. 3 is an cross sectional view, taken along line III-III of FIG. 1;

FIG. 4 shows that the socket of the present invention and the threaded section of a bolt is inserted into the driving portion of the socket;

FIG. 5 shows that the distal end of the threaded section of the bolt contacts the first shoulder, and the nut on the bolt is engaged with the driving portion of the socket;

FIG. 6 shows a conventional socket, and

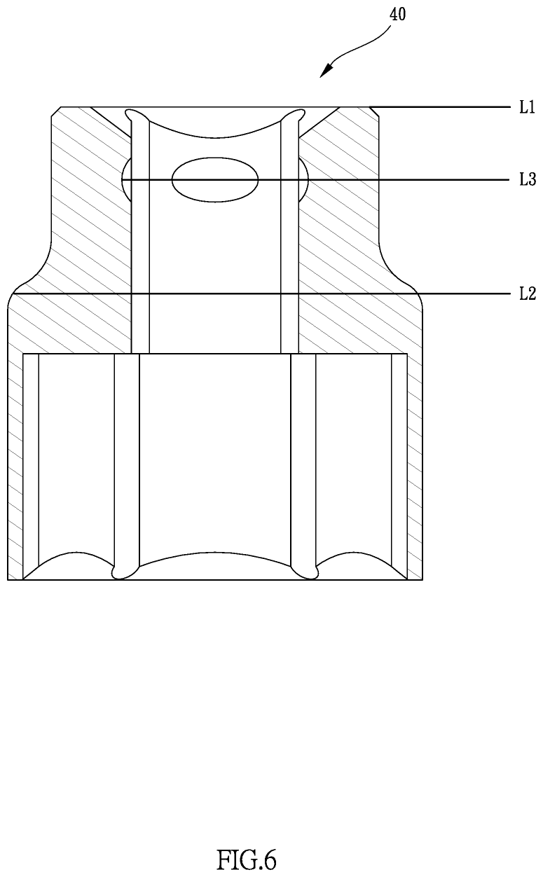

FIG. 7 shows that the bolt is inserted into the conventional socket but the nut on the bolt cannot be accessed by the conventional socket.

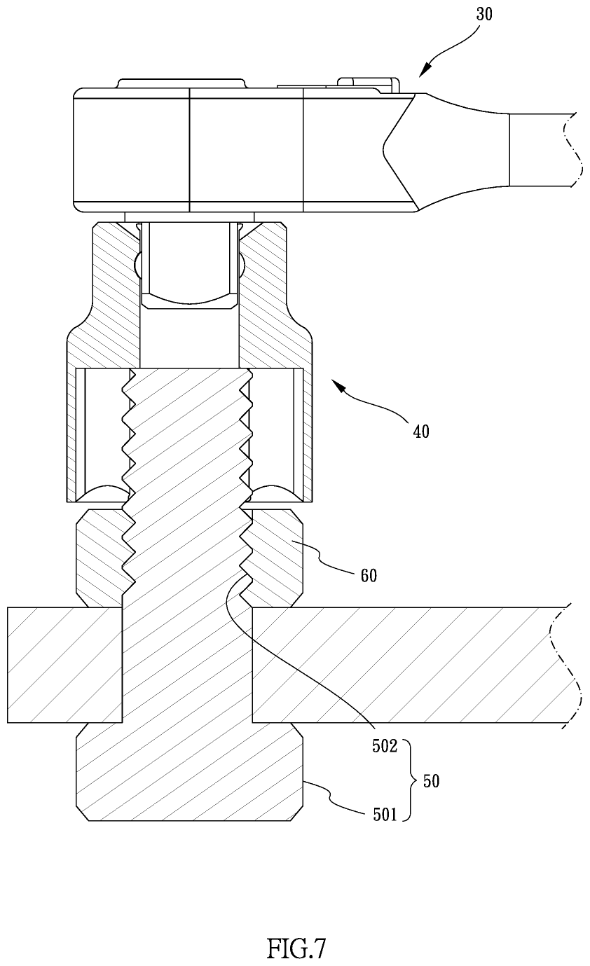

### DETAILED DESCRIPTION OF THE PREFERRED EMBODIMENT

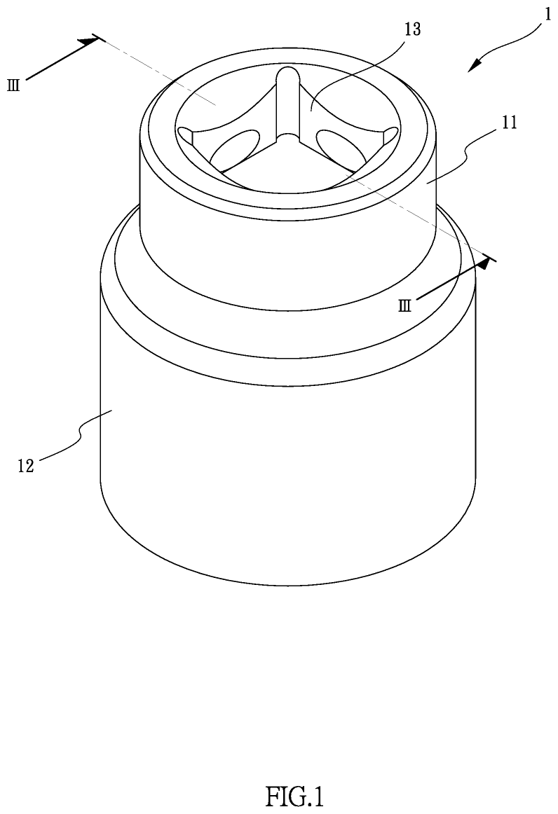

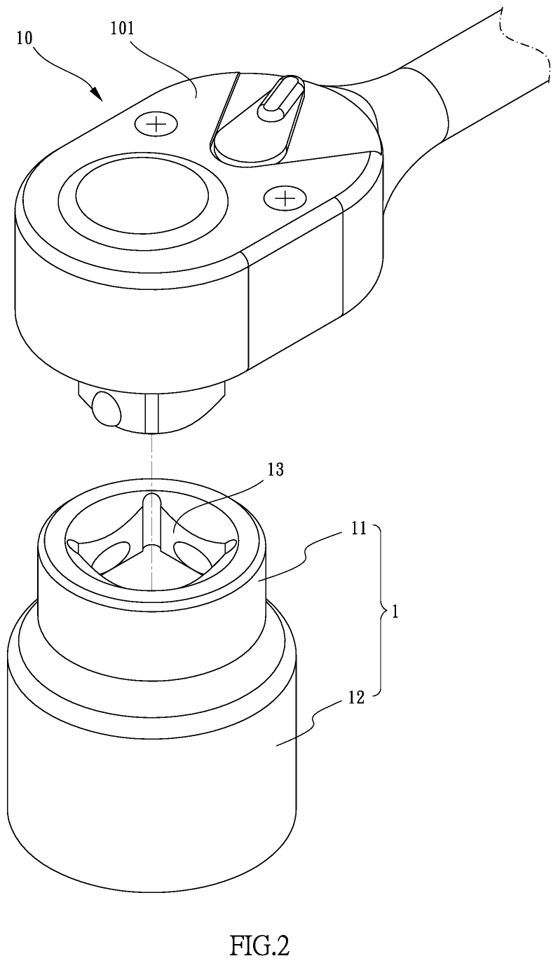

Referring to FIGS. 1 to 5, the socket 1 of the present invention comprises a connection section 11 and a driving section 12 which is formed integrally with the connection section 11. A through hole 13 is defined through the connection section 11 and the driving section 12, and the through hole 13 includes a connection portion 131, a transition portion 132 and a driving portion 133 of different diameters. The connection portion 131 is to be connected with a driving head 101 of a ratchet wrench 10, and the driving portion 133 is to be mounted to a head 201 of a bolt 20 or a nut 30. The connection portion 131 has at least one notch 2 defined in the inside thereof so as to secure the driving square of the ratchet wrench 10.

The transition portion 132 is located between the connection portion 131 and the driving portion 133, so that a first shoulder 134 is formed between the connection portion 131 and the transition portion 132, and a second shoulder 135 is formed between the transition portion 132 and the driving portion 133. In this embodiment, the first shoulder 134 is in flush with the lower edge of the at least one notch 2.

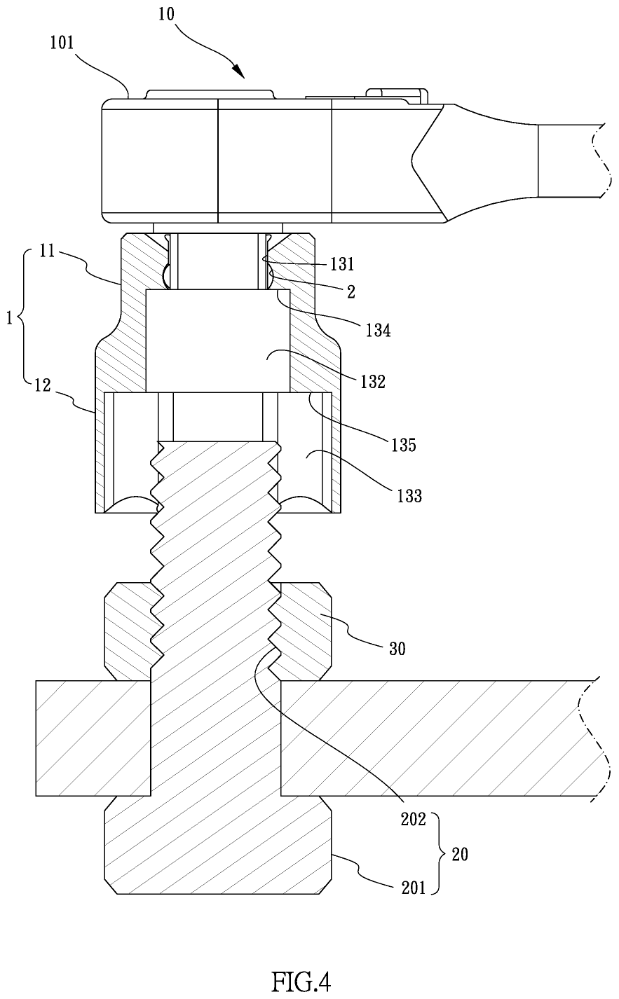

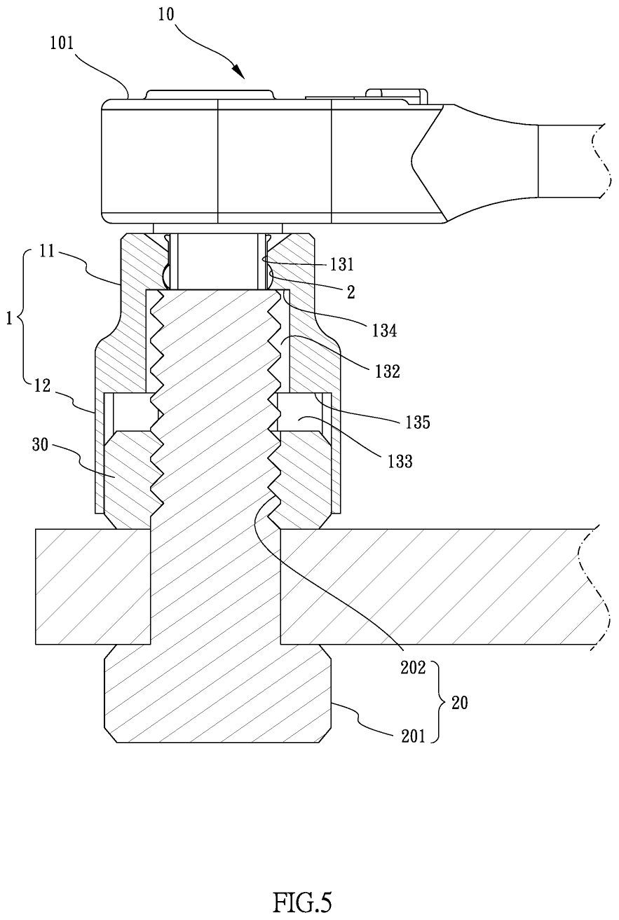

The diameter of the transition portion 132 is larger than the axial length of the connection portion 131. The axial length of the transition portion 132 is longer than ¼ of the length of the driving portion 133. As shown in FIGS. 4 and 5, the driving square of the ratchet wrench 10 is engaged with the connection portion 131 of the socket 1, when the threaded section 202 is inserted into the socket 1 from the driving portion 133 of the through hole 13, the threaded section 202 extends through the driving portion 133 and is inserted into the transition portion 132. The first shoulder 134 contacts the distal end of the threaded section 202 of the bolt 20, and the nut 60 is engaged with the driving portion 133. The second shoulder 135 contacts the nut 30 when the height of the nut 30 is longer than the axial length of the driving portion 133. Therefore, when rotating the ratchet wrench 10, the nut 30 can be rotated.

In this embodiment, the connection portion 131 of the through hole 13 is a rectangular portion, and the transition portion 132 of the through hole 13 is a circular portion. The diameter of the transition portion 133 is smaller or equal to the length of the diagonal of the rectangular portion of the connection portion 131. The diameter of the transition portion 132 is defined as “D”, and the length of a diagonal of the connection portion 131 is defined as “d”, wherein D>d. Therefore, the threaded section 202 can extend through the transition portion 132 and contacts the first shoulder 134 so as to prevent the threaded section 202 to impact the contacts the ratchet wrench 10.

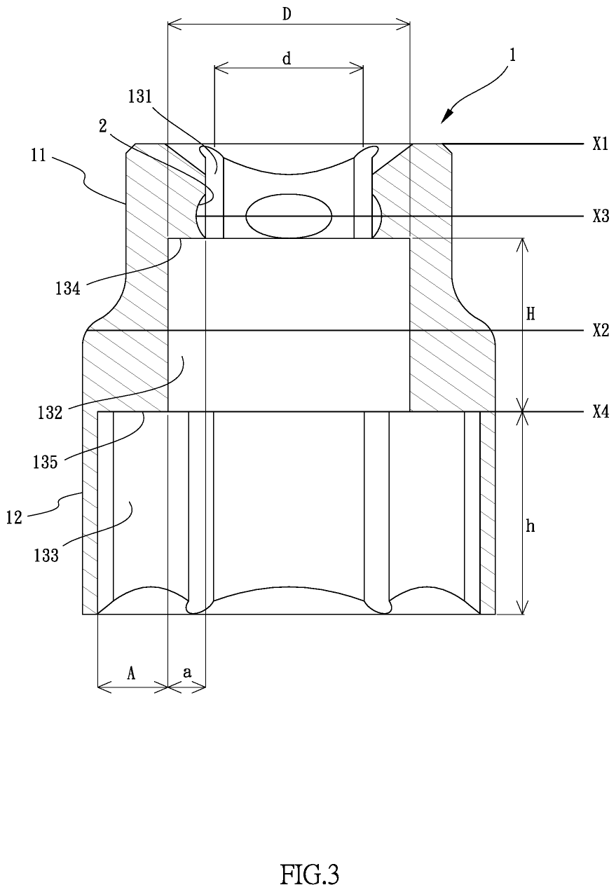

Furthermore, as shown in FIG. 3, a first line X1 is defined to extend from the top surface of the connection section 11. A second line X2 is defined to pass the middle point of the transition portion 132 and perpendicular to the socket 1. A third line X3 is defined to pass through the center of the at least one notch 2 and perpendicular to the axis of the socket 1. A fourth line X4 is defined to extend from the second shoulder 134. The height of the transition portion 132 is defined as “H”, wherein the “H” is larger than ⅘ of the distance between the third line X3 and fourth line X4. The height of the driving portion 133 is defined as “h” wherein the “H” is larger than ¼ or the “h”. The width of the first shoulder 134 is defined as “a”, the width of the second shoulder 135 is defined as “A”, wherein A>a, and H>A+a.

The socket 1 of the present invention has shorter axial length and allows the socket 1 of the present invention to loosen or tighten the nut 30 in FIG. 5.

While we have shown and described the embodiment in accordance with the present invention, it should be clear to those skilled in the art that further embodiments may be made without departing from the scope of the present invention.

What is claimed is:

1. A socket comprising:
a connection section and a driving section which is formed integrally with the connection section, a through hole defined through the connection section and the driving section, the through hole including a connection portion, a transition portion and a driving portion, the connection portion adapted to be connected with a ratchet wrench, the driving portion adapted to be mounted to a head of a bolt or a nut, the transition portion located between the connection portion and the driving portion, a first shoulder formed between the connection portion and the transition portion, a second shoulder formed between the transition portion and the driving portion, the first shoulder adapted to contact a distal end of a threaded section of the bolt, and the driving portion is adapted to engage with the nut on the bolt when the threaded section is inserted into the socket from the driving portion of the through hole.

2. The socket as claimed in claim 1, wherein the connection portion of the through hole is a rectangular portion, the transition portion of the through hole is a circular portion, a diameter of the transition portion is smaller or equal to a length of a diagonal of the rectangular portion of the connection portion.

3. The socket as claimed in claim 1, wherein the connection portion has at least one notch defined in an inside thereof.

4. The socket as claimed in claim 3, wherein the first shoulder is in flush with a lower edge of the at least one notch.

5. The socket as claimed in claim 4, wherein a first line is defined to extend from a top surface of the connection section, a second line is defined to pass a middle point of the transition portion and perpendicular to the socket, a third line is defined to pass through a center of the at least one notch and perpendicular to an axis of the socket, a fourth line is defined to extend from the second shoulder, a height of the transition portion is defined as “H”, wherein the “H” is larger than ⅘ of a distance between the third line and fourth line, a height of the driving portion is defined as “h”, wherein the “H” is larger than ¼ of the “h”.

6. The socket as claimed in claim 5, wherein a diameter of the transition portion is defined as “D”, a length of a diagonal of the connection portion is defined as “d”, wherein D>d.

7. The socket as claimed in claim 6, wherein a width of the first shoulder is defined as “a”, a width of the second shoulder is defined as “A”, wherein A>a, and H>A+a.
